(19) United States
(12) Patent Application Publication
(10) Pub. No.: US 2008/0311384 A1
(43) Pub. Date: Dec. 18, 2008

(54) COATING COMPOSITION

(76) Inventors: Christopher Arend Toles, Escondido, CA (US); Mohammad-Reza Rayatparvar T., Carlsbad, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/764,033

(22) Filed: Jun. 15, 2007

(51) Int. Cl. C09D 11/00; B32B 5/16

(52) U.S. Cl. 428/328; 106/31.9

(57) ABSTRACT

One or more inkjet coating compositions and coated substrates are disclosed. The coating compositions may comprise a nanomilled aluminum trihydrate pigment and a binder. Also disclosed are methods for the production of the coating composition and media substrates coated with the composition.

### BACKGROUND

Aluminum trihydrate (ATH) is the general name for the chemical compound Al(OH)₃, which occurs as three phases: gibbsite, nordstrandite, and bayerite. Gibbsite is a tabular monclinic crystal with a generally hexagonal outline. Nordstrandite is a triclinic crystal and bayerite is a tabular monoclinic crystal.

Though alumina hydrate, particularly of the boehmite structure, has been used to provide a glossy inkjet media, many grades of aluminum trihydrate particles of sufficiently low costs are too large to function as effective gloss-enhancing layers for inkjet applications. Thus, it would be desirable to provide cost-effective pigment alternatives for paper coating applications, which further provide desirable black optical density and color gamut.

### DETAILED DESCRIPTION

In the following description, for purposes of explanation, numerous specific details are set forth in order to provide a thorough understanding of one or more aspects of the disclosure herein. It may be evident, however, that one or more aspects of the disclosure herein may be practiced with a lesser degree of these specific details.

The disclosure relates to an inkjet coating composition and a coated media sheet produced therefrom. The coating composition and coated media sheet have an improved black optical density and high gloss. The coated sheet comprises a substrate, a primary coating layer and a top coating layer. Both single-sided and double-sided coated embodiments are within the scope of the disclosure herein. Here and elsewhere in the specification and claims, the ranges and ratio limits may be combined.

The term “overlies” and cognate terms such as “overlying” and the like, when referring to the relationship of one or a first layer relative to another or a second layer, refers to the fact that the first layer partially or completely overlies the second layer. The first layer overlying the second layer may or may not be in contact with the second layer. For example, one or more additional layers may be positioned between the first layer and the second layer.

In one embodiment, the coating composition is applied to a substrate or media substrate. “Substrate” or “media sheet” includes any material that can be coated in accordance with an embodiment of the disclosure herein, including but not limited to film base substrates, polymeric substrates, conventional paper substrates, clay coated paper, glassine, paperboard, cellulosic paper, photobase substrates, and the like. Further, pre-coated substrates, such as polymeric coated substrates or swellable media, can also be coated in embodiments of the invention.

### Primary Coating Layer

In one embodiment, a “base” or “primary coating” layer overlies the substrate. The primary coating layer may be comprised of a blend of any suitable coating pigments. In one embodiment, the primary coating comprises a blend of an inorganic pigment and a binder. The inorganic pigment may include one or more of alumina, silica, titanium oxide, calcined clay, kaolinite clay, and/or calcium carbonate. In one embodiment, the inorganic pigment comprises calcium carbonate particles. The particulate calcium carbonate is supplied either as mechanically treated natural calcium carbonate material, or as a chemically synthesized reaction product.

The calcium carbonate particles can be ground natural calcium carbonate. Marble, limestone, chalk and coral, for example, are natural sources of calcium carbonate. Alternatively, the calcium carbonate particles can be supplied as a synthetic reaction product in the form of precipitated calcium carbonate. The precipitated calcium carbonate products have a more uniform particle size distribution, and a higher degree of chemical purity, than commercially available ground calcium carbonate.

In addition to the inorganic pigment, the primary coating layer may also comprise a binder. In one embodiment, the primary coating layer contains a binder comprising one or more of polyvinyl alcohol, polyvinyl acetate, polyvinyl acetal, polyacrylic acid and derivatives thereof, starch, cellulosics, carboxycellulosics, polyvinyl pyrrolidone, polyurethane, polyvinyl alcohol (PVA) and derivatives thereof, styrene-butadiene latex, gelatin, alginates, casein, polyethylene glycol (PEG), a poly(vinyl pyrrolidone-vinyl acetate) copolymer, poly(vinyl acetate-ethylene) copolymer, and/or poly(vinyl alcohol-ethylene oxide) copolymer. In one embodiment, the binder comprises PVA. In one embodiment, the binder is present in an amount from about 5 parts (based on 100 parts dry inorganic pigment) to about 50 parts (based on 100 parts dry inorganic pigment). In another embodiment, the binder is present in an amount from about 10 parts (based on 100 parts dry inorganic pigment) to about 25 parts (based on 100 parts dry inorganic pigment).

The primary coating can be applied to the substrate using any coating technique(s), including blade coating, air knife coating, rod coating, gravure coating, cast coating, and/or other techniques, for example. The primary coating layer has a thickness from about 10 to about 35 grams per square meter (g/m²), or from about 15 to about 25 (g/m²) thick. Following application, the primary coating may be dried by any suitable means, such as drum dryers, forced air dryers, gas and/or electric IR dryers, for example.

### Top Coating Layer

In one embodiment, a top coating layer is applied overlying the primary coating layer. In one embodiment, the top coating layer comprises an aluminum trihydrate nanopigment and a binder. The ATH nanopigment comprises particulate aluminum trihydrate which has been milled to provide nanoparticles of ATH. In one embodiment the nanoparticles of ATH have a size of less than 180 nanometers (nm). In another embodiment, the ATH nanoparticles are less than 160 nm.

In one embodiment, the ATH nanoparticles account for from about 15 wt % to about 40 wt % of the milled slurry and in one embodiment, from about 30 wt % to about 35 wt % of the milled slurry.

The binder for use with respect to the top coating layer can, in one embodiment, comprise one or more binders in common with the binder of the primary coating layer. In one embodiment, the binder of the top coating layer is different than the binder of the primary coating layer. In one embodiment, the binder comprises PVA. The PVA comprises a low to medium molecular weight (M_{W}) low percent hydrolysis PVA. In one embodiment, the MW is from about 13,000 to about 30,000, and the percent (%) hydrolysis is from about 86% to about 99%. The amount of binder comprises, in one embodiment, from about 1 part to about 30 parts based upon 100 parts of pigment in the coating. In one embodiment, the amount of binder comprises from about 5 parts to about 20 parts based on 100 parts of pigment in the coating.

In one embodiment the top coating layer comprises a crosslinking agent in an amount from about 0.2 parts to about 5 parts based on 100 parts of pigment in the coating. In one embodiment the top coating layer comprises a crosslinking agent in an amount from about 0.2 parts to about 1 parts based on 100 parts of pigment in the coating. The crosslinking agent comprises one or more of a boron-containing crosslinker, including boric acid, borax, or borates, or a non-boron containing crosslinker, including glyoxal, glutaraldehyde, aldehyde compounds, zirconium sulfate, zirconium acetate, and/or epoxides, for example.

In one embodiment the top coating layer comprises a cationic material. The cationic material may include, for example, one or more of a cationized aluminum chloride-treated silica, pseudoboehmite, cationized kaolinite, aluminum chlorohydrate-treated silica, aminosilane-treated silica, aminosilane-treated kaolinite, and other cationized mineral pigments, and the like. The cationic material may be present in an amount from about 15 parts to about 50 parts based on 100 parts of pigment in the coating.

The coating may contain humectants, surfactants, dye fixatives, dyes, optical brighteners, UV absorbers coating rheology modifiers, surfactants, thickeners, deforming agents, preservatives, cast coating releasing agents, fillers, defoamers, lubricants, crosslinkers, dispersants, viscosity modifiers, pH adjusters, defoamers and/or any other suitable additives.

The top coating is prepared by one or more techniques for nanomilling of the ATH particles, including nanomilling, bead milling, horizontal bead milling, planetary ball milling, jet milling (microniser), submicron wet bead milling, and/or colloid milling, for example. A mill is charged with distilled water and sufficient acid to lower the pH to about 2. In one embodiment, an ATH powder is inducted into the mill to bring the total solids up to about 30% to about 40% ATH. The pH is monitored throughout the grind and acid is added to maintain the pH at about 4. Particle size is measured intermittently using light scattering techniques to determine if the particles are in the target size range. When the target size is achieved, the grind is stopped and the dispersion is decanted from the mill. Following formation of the ATH nanopigment, the top coating composition is formed by mixing a slurry of the ATH with binder and water to form an aqueous composition. In one embodiment, the total solids of the top coating composition is about 20 wt %.

The top coating can be applied to the primary coating using any suitable coating device. In accordance with embodiments of the disclosure herein, various coating techniques can be implemented by preparing a coating solution/dispersion to be coated on a media sheet. For example, a substrate can be coated by spray coating, dip coating, cascade coating, swirl coating, extrusion hopper coating, curtain coating, air knife coating, cast coating, rod coating, and/or by using other suitable coating techniques. The thickness selected for each coated layer can depend upon the particular requirement or application and/or by desired properties, as would be ascertainable by one skilled in the art. The top coating is applied, in one embodiment, at a coating weight of about 0.5 g/m² to about 15 g/m². In one embodiment, the top coating is applied at a coating weight of about 10 g/m². The top coating may be applied to at least one surface of the substrate.

Following application of the top coating layer to the substrate, the substrate may be subjected to further processing steps. For example, the substrate may be calendared to further improve gloss or smoothness and other properties of the papers. For example, the substrate is calendared by passing the coated substrate through a nip formed by a calendar roll having a temperature of about room temperature to about 200° C. and a pressure of about 689 to about 20684 kPa (kilopascals) (100 to 3000 psi).

The following examples illustrate various formulations for preparing the coatings for the coating compositions of the invention. The following examples should not be considered as limitations of the disclosure herein, but are merely provided to teach how to make the coatings and coated substrates based upon current experimental data.

### EXAMPLES

### Example 1

A primary coating composition was prepared using the Table 1 formulation:

TABLE 1

| Component | Role | Dry Parts |
|---|---|---|
| Calcium carbonate | Inorganic pigment | 60 |
| Calcined kaolinite | Inorganic pigment/spacer | 40 |
| Polyvinyl alcohol | Binder | 0.5 |
| Latex plastic | Binder | 10 |
| Defoamer | Defoamer | 0.2 |
| Surfactant | Wetting agent | 0.2 |

The primary coating was applied to a plain paper sheet substrate at approximately 25 grams per square meter (g/m²) using a meyer rod coating technique. The coated sheet was then dried for approximately 20 to 30 minutes at 120° C. in a forced draft oven.

A top coating composition was prepared using the Table 2 formulation:

TABLE 2

| Component | Role | Dry Parts |
|---|---|---|
| Aluminum trihydrate | Inorganic Pigment | 100 |
| Polyvinyl Alcohol | Binder | 10 |
| Boric Acid | Crosslinking Agent | 1 |

The topcoating composition was applied over the primary coating using a #15 Meyer Rod to a coating weight of approximately 10 g/m². The coated sheet was then dried for approximately 20 to 30 minutes at 120° C. in a forced draft oven.

The coated sheet was then calendared at a temperature of 93° C. and a pressure of 20596 kPa (3000 psi) for four (4) passes through a calendar (Model 2R-Cal manufactured by Independent Machine, Fairfield, N.J.), resulting in a 20° Gloss measurement of 28 and a 600 Gloss measurement of 65, as measured using a Byk-Gardner Tri Gloss Meter.

A print was made using dye ink on an inkjet printer. Black Optical Density was measured using an X-Rite 938 Spectrodensitometer and Color Gamut was measured using a Gretag macBeth Spectroscan unit. The invention coating was compared against a commercial silica-based porous inkjet medium in terms of unprinted gloss, black optical density and color gamut, the results of which are shown in Table 3.

TABLE 3

| | | Color | | |
|---|---|---|---|---|
| | Black | Gamut | | |
| | Optical | (CieLAB | 20° | 60° |
| Coating ID | Density | volume) | Gloss | Gloss |
| Silica-based | 1.56 | 416,558 | 36 | 57 |
| photoglossy inkjet | | | | |
| paper | | | | |
| Example 1 | 1.69 | 386,527 | 28 | 65 |

### Example 2

A top coating composition was made according to the formulations in Table 4:

TABLE 4

| Component | Role | Dry Parts |
|---|---|---|
| Aluminum trihydrate | Inorganic pigment | various |
| Cationic silica | Inorganic pigment | Various |
| Polyvinyl alcohol | Binder | 10 |
| Boric acid | Crosslinking agent | 1 |

The ratio of ATH to cationic silica was varied from 5:1 ATH:silica to 2:1 ATH:silica (dry basis). The topcoats were then applied to the coated base according to Example 1 using a #24 Meyer rod.

The samples were then calendared 2 passes at a temperature of 93° C. and a pressure of 20,596 kPa (3000 psi). 200 and 600 Gloss measurements indicated an unexpected improvement in gloss at an equal ratio of cationized silica:ATH.

### Example 3

A top coating composition was made according to the formulations in Table 5:

TABLE 5

| Component | Role | Dry Parts |
|---|---|---|
| Aluminum trihydrate | Inorganic pigment | various |
| Pseudoboehmite | Inorganic pigment | Various |
| Polyvinyl alcohol | Binder | 10 |
| Boric acid | Crosslinking agent | 1 |

The ratio of ATH to pseudoboehmite was varied from 5:1 ATH:PB to 1:1 ATH:PB (dry basis). The topcoats were then applied to the coated base according to Example 1 using a #24 Meyer rod.

The samples were then calendared 2 passes at a temperature of 93° C. and a pressure of 20,596 kPa (3000 psi). As shown in Table 6, 20° and 60° Gloss measurements indicated an unexpected improvement in gloss at an equal ratio of pseudoboehmite:ATH.

TABLE 6

| Coating ID | 20° Gloss | 60° Gloss |
|---|---|---|
| ATH Only | 27 | 66 |
| 83% ATH/17% PB | 27 | 63 |
| 50% ATH/50% PB | 27 | 57 |

Although the disclosure has been shown and described with respect to one or more embodiments and/or implementations, equivalent alterations and/or modifications will occur to others skilled in the art based upon a reading and understanding of this specification. The disclosure is intended to include all such modifications and alterations and is limited only by the scope of the following claims. In addition, while a particular feature may have been disclosed with respect to only one of several embodiments and/or implementations, such feature may be combined with one or more other features of the other embodiments and/or implementations as may be desired and/or advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A coated media sheet comprising:
a substrate
a primary coating layer; and
a top coating layer comprising an aluminum trihydrate nanopigment and a binder.

2. The coated media sheet of claim 1, the primary coating comprising an inorganic pigment and a binder.

3. The coated media sheet of claim 1, the substrate comprising one or more of film base substrates, polymeric substrates, paper substrates, clay coated paper, glassine, paperboard, cellulosic paper, photobase substrates, pre-coated substrates, polymeric coated substrates and/or swellable media.

4. The coated media sheet of claim 1, the aluminum trihydrate nanopigment comprising nanoparticles of less than 180 nm.

5. The coated media sheet of claim 4, the top coating layer comprising a binder comprising one or more of polyvinyl alcohol, polyvinyl acetate, polyvinyl acetal, polyacrylic acid and derivatives thereof, starch, cellulosics, carboxycellulosics, polyvinyl pyrrolidone, polyurethane, polyvinyl alcohol (PVA) and derivatives thereof, styrene-butadiene latex, gelatin, alginates, casein, polyethylene glycol (PEG), a poly(vinyl pyrrolidone-vinyl acetate) copolymer, poly(vinyl acetate-ethylene) copolymer, and/or poly(vinyl alcohol-ethylene oxide) copolymer.

6. The coated media sheet of claim 5, the binder comprising PVA.

7. An inkjet coating composition comprising:
an aluminum trihydrate nanopigment; and
a binder.

8. The composition of claim 7, the binder comprising one or more of polyvinyl alcohol, polyvinyl acetate, polyvinyl acetal, polyacrylic acid and derivatives thereof, starch, cellulosics, carboxycellulosics, polyvinyl pyrrolidone, polyurethane, polyvinyl alcohol (PVA) and derivatives thereof, styrene-butadiene latex, gelatin, alginates, casein, polyethylene glycol (PEG), a poly(vinyl pyrrolidone-vinyl acetate) copolymer, poly(vinyl acetate-ethylene) copolymer, and/or poly(vinyl alcohol-ethylene oxide) copolymer.

9. The composition of claim 8, the binder comprising PVA in an amount from about 1 part to about 30 parts per 100 parts of aluminum trihydrate nanopigment.

10. The composition of claim 9, the aluminum trihydrate nanopigment comprising nanoparticles of less than 180 nm.

11. The composition of claim 2, comprising a cross-linking agent.

12. The composition of claim 11, comprising a cross-linking agent in an amount from about 0.2 parts to about 5 parts based on 100 parts of pigment in the composition.

13. The composition 7, the cross-linking agent comprising one or more of boric acid, borax, borates, glyoxal, glutaraldehyde, aldehyde compounds, zirconium sulfate, zirconium acetate, and/or epoxides.

14. The composition of claim 7, comprising a cationic material.

15. A method of making a coating composition comprising:
milling a slurry of aluminum trihydrate to form nanoparticles thereof;
mixing the slurry of aluminum trihydrate nanoparticles with a binder and water to form an aqueous coating composition.

16. The method of claim 15, the slurry of aluminum trihydrate comprising from about 15 wt % to about 40 wt % aluminum trihydrate.

17. The method of claim 15, the aluminum trihydrate nanoparticles milled to a particle size of less than 180 nm.

18. The method of claim 15, the total solids comprising 20% of the coating composition.

19. The method of claim 15, comprising forming a coated substrate by applying the coating composition to at least one surface of the substrate.

20. The method of claim 19, the coating composition applied at a coating weight of from about 0.5 g/m² to about 15 g/m².
